(19) United States
(12) Patent Application Publication
(10) Pub. No.: US 2026/0140343 A1
(43) Pub. Date: May 21, 2026

(54) OPTICAL FIBER MANAGEMENT APPARATUS FOR CO-PACKAGED OPTICS SWITCH CHIP

(71) Applicant: Ruijie Networks Co., Ltd., Fuzhou (Fujian) (CN)

(72) Inventors: Xiangguo JIA, Fuzhou (CN); Wei LIU, Fuzhou (CN)

(21) Appl. No.: 19/442,015

(22) Filed: Jan. 7, 2026

Related U.S. Application Data
(63) Continuation of application No. PCT/CN2024/134678, filed on Nov. 26, 2024.

(30) Foreign Application Priority Data
Dec. 1, 2023 (CN) 202323284679.5

(51) Int. Cl. G02B 6/44

(52) U.S. Cl. CPC G02B 6/44465; G02B 6/4448; G02B 6/4461

(57) ABSTRACT

This application relates to an optical fiber management apparatus for co-packaged optics switch chip. The apparatus includes: a support substrate including a first surface; an optical fiber storage box disposed on the first surface of the support substrate; and a cable management structure disposed on the first surface of the support substrate and including: a cable management portion having a first optical fiber outlet; and a first optical fiber storage space having a second optical fiber outlet, where the first optical fiber outlet is configured to allow an optical fiber in the cable management portion to extend into the first optical fiber storage space, the second optical fiber outlet is configured to allow the optical fiber in the first optical fiber storage space to extend into the optical fiber storage box, and the first optical fiber storage space is configured to accommodate a first redundant portion of the optical fiber.

### CROSS-REFERENCE TO RELATED APPLICATIONS

This application is a continuation of International Application No. PCT/CN2024/134678, filed on Nov. 26, 2024, which claims priority to Chinese Patent Application No. 202323284679.5, filed with the China National Intellectual Property Administration on Dec. 1, 2023, entitled “OPTICAL FIBER MANAGEMENT APPARATUS FOR CO-PACKAGED OPTICS SWITCH CHIP”, both of which are incorporated by reference into this application in their entireties.

### TECHNICAL FIELD

This application relates to the field of communication technologies, and particularly to an optical fiber management apparatus for co-packaged optics switch chip.

### BACKGROUND

With the continuous increase in port speeds of data center switches, thermal dissipation in high-power optical modules has become a system bottleneck. Co-packaged optics (Co-Packaged Optics, CPO) serves as a crucial solution—an innovative packaging technology that integrates chips and optoelectronic components into a single unit. This approach offers advantages, including reduced packaging costs, improved packaging efficiency, and enhanced system performance.

### SUMMARY

This application discloses an optical fiber management apparatus for co-packaged optics switch chip.

Embodiments of this application provide the following technical solutions.

An optical fiber management apparatus for co-packaged optics switch chip includes: a support substrate, a panel, an optical fiber storage box, and a cable management structure;
the panel is mounted at an end portion of the support substrate; and
the support substrate includes a first surface, and both the optical fiber storage box and the cable management structure are fixedly disposed on the first surface; the cable management structure includes a hollowed-out region configured to expose a chip assembly fixedly disposed on the support substrate; along an optical fiber routing direction, an optical fiber inlet of the cable management structure faces the hollowed-out region, an optical fiber inlet of the optical fiber storage box is opposite to an optical fiber outlet of the cable management structure, and an optical fiber outlet of the optical fiber storage box is opposite to an optical fiber interface on the panel; and an interior of the optical fiber storage box and/or the cable management structure has an optical fiber storage space.

The above optical fiber management apparatus is configured to manage optical fibers of a co-packaged optics switch chip, where a chip assembly including the co-packaged optics switch chip is mounted on the first surface of the support substrate and located within the hollowed-out region of the cable management structure. Both the cable management structure and the optical fiber storage box are fixed on the first surface of the support substrate, and the panel is fixed at the end portion of the support substrate; and optical fibers connected to the chip assembly pass through the cable management structure and the optical fiber storage box to reach the panel, thereby transmitting optical signals to the panel. The cable management structure surrounds the chip assembly via the hollowed-out region, facilitating entry of optical fibers into the cable management structure. In addition, optical devices at different positions around the chip in the chip assembly require optical fibers of varying lengths for signal connection to the panel, and the design combining the cable management structure and the optical fiber storage box provides additional optical fiber storage space. An interior of the cable management structure may have an optical fiber storage space, and an interior of the optical fiber storage box may also have an optical fiber storage space, facilitating accommodation of redundant optical fiber portions.

An optical fiber management apparatus for co-packaged optics switch chip includes:
a support substrate including a first surface;
an optical fiber storage box disposed on the first surface of the support substrate; and
a cable management structure disposed on the first surface of the support substrate and including:
a cable management portion having a first optical fiber outlet; and
a first optical fiber storage space having a second optical fiber outlet, where the first optical fiber outlet is configured to allow an optical fiber in the cable management portion to extend into the first optical fiber storage space, the second optical fiber outlet is configured to allow the optical fiber in the first optical fiber storage space to extend into the optical fiber storage box, and the first optical fiber storage space is configured to accommodate a first redundant portion of the optical fiber.

In some embodiments, the optical fiber storage box includes a second optical fiber storage space, and the second optical fiber storage space is configured to accommodate a second redundant portion of the optical fiber.

In some embodiments, the apparatus further includes:
a panel mounted at an end portion of the support substrate; and
the cable management portion further includes a hollowed-out region and a plurality of optical fiber inlets; where openings of the plurality of optical fiber inlets of the cable management portion face the hollowed-out region.

In some embodiments, an elastic shielding member is disposed between the optical fiber storage box and the panel.

In some embodiments, the elastic shielding member is conductive cotton.

In some embodiments, the hollowed-out region is located at a central portion of the cable management portion, and the plurality of optical fiber inlets are spaced apart around the hollowed-out region.

In some embodiments, the hollowed-out region has a square structure, the cable management portion is provided with four optical fiber inlets, and the four optical fiber inlets are respectively disposed corresponding to four sides of the hollowed-out region.

In some embodiments, an optical fiber fixing assembly is disposed at the optical fiber inlet of the cable management portion and/or at the optical fiber inlet of the optical fiber storage box; where
the optical fiber fixing assembly includes an optical fiber fixing base and an optical fiber fixing pressing block; and
the optical fiber fixing base is provided with an optical fiber fixing groove extending through the optical fiber fixing base, where an opening is provided on a side of the optical fiber fixing groove facing away from the support substrate, and the optical fiber fixing pressing block is fixedly disposed on the optical fiber fixing base and covers the opening.

In some embodiments, an elastic member is provided between the optical fiber fixing base and the optical fiber fixing pressing block.

In some embodiments, the elastic member is foam.

In some embodiments, the cable management structure includes a main body and a protective cover, and the protective cover covers a side of the main body facing away from the support substrate.

In some embodiments, the protective cover includes a first protective cover and a second protective cover; the first protective cover corresponds to the hollowed-out region of the cable management portion; and the second protective cover corresponds to the first optical fiber storage space of the cable management structure.

In some embodiments, the first optical fiber storage space is provided with a plurality of optical fiber-through grooves at the second optical fiber outlet.

In some embodiments, the panel is provided with a connector; the connector includes a first portion and a second portion, the first portion is located within the optical fiber storage box, and the second portion extends through the panel and extends beyond an outer surface of the panel.

In some embodiments, an end of the second portion extending beyond the outer surface of the panel is provided with a dust cap.

In some embodiments, a plurality of optical fiber storage boxes are provided, and the plurality of optical fiber storage boxes are arranged along an extension direction of the panel.

In some embodiments, the optical fiber storage box includes a box body and a lid; and the lid of the optical fiber storage box is located on a side surface of the box body.

In some embodiments, the lid of the optical fiber storage box is a side having the largest area among a plurality of sides of the optical fiber storage box.

In some embodiments, the optical fiber storage box includes a box body and a lid, both the optical fiber inlet and the optical fiber outlet of the optical fiber storage box are disposed on the box body, and the lid covers the box body.

In some embodiments, a volume of the optical fiber storage box is smaller than a volume of the cable management structure.

### BRIEF DESCRIPTION OF DRAWINGS

To more clearly illustrate technical solutions in the embodiments of this application or in the prior art, a brief introduction to the drawings required for describing the embodiments or the prior art is provided below. Apparently, the drawings described below are merely some embodiments of this application; for persons of ordinary skill in the art, additional drawings can be obtained based on these drawings without creative effort.

FIG. 1 is a schematic structural diagram of an optical fiber management apparatus according to an embodiment of this application; and

FIG. 2 is an exploded view of a partial structure of an optical fiber management apparatus according to an embodiment of this application.

Reference numerals: 1. support substrate; 2. panel; 3. optical fiber storage box; 31. box body; 32. lid; B. second optical fiber storage space; 4. cable management structure; 41. main body; 411. optical fiber-through groove; 42. protective cover; 421. first protective cover; 422. second protective cover; 43. hollowed-out region; 44. first optical fiber outlet; 45. cable management portion; 46. second optical fiber outlet; A. first optical fiber storage space; 48. optical fiber inlet; 5. chip assembly; 51. optical device; 511. optical fiber; 6. mainboard; 7. conductive cotton; 8. optical fiber fixing assembly; 81. optical fiber fixing base; 82. optical fiber fixing pressing block; 83. foam; 9. connector; and 91. dust cap.

### DESCRIPTION OF EMBODIMENTS

The technical solutions in the embodiments of this application are described clearly and completely below in conjunction with the drawings in the embodiments of this application. Apparently, the described embodiments are merely a portion of the embodiments of this application, rather than all embodiments. Based on the embodiments in this application, all other embodiments obtained by a person of ordinary skill in the art without creative effort fall within the scope of protection of this application. In the description of the embodiments of this application, unless otherwise specified, “/” means “or,” for example, A/B can mean A or B; “and/or” in the text merely describes an associative relationship between associated objects, indicating three possible relationships: A exists alone, A and B exist simultaneously, or B exists alone. Additionally, in the description of the embodiments of this application, unless otherwise specified, “a plurality of” refers to two or more.

Hereinafter, the terms “first” and “second” are used for descriptive purposes only and shall not be construed as implying or suggesting relative importance or implicitly indicating the number of technical features specified. Thus, a feature defined with “first” or “second” may explicitly or implicitly include one or more of that feature. In the description of the embodiments of this application, unless otherwise specified, “a plurality of” means two or more.

In the description of this application, it should be noted that, unless explicitly specified and limited otherwise, the terms “mount,” “connect,” and “join” should be understood in a broad sense, such as a fixed connection, a detachable connection, or an integral connection, a direct connection, an indirect connection through an intermediate medium, or an internal communication of two elements. Persons of ordinary skill in the art can understand the specific meanings of these terms in this application as appropriate to specific situations.

In the description of this application, it should be understood that the orientation or positional relationships indicated by terms such as “center,” “upper,” “lower,” “front,” “rear,” “left,” “right,” “vertical,” “horizontal,” “top,” “bottom,” “inner,” and “outer” are based on the orientation or positional relationships shown in the drawings, intended solely to facilitate the description of this application and simplify the description, rather than indicating or implying that the referred apparatus or element must have a specific orientation, be constructed, and operate in a specific orientation; thus, these terms shall not be construed as limiting this application.

With the continuous increase in port speeds of data center switches, thermal dissipation in high-power optical modules has become a system bottleneck. CPO serves as a critical solution—an innovative packaging technology that integrates chips and optoelectronic components into a single unit. This approach offers advantages, including reduced packaging costs, improved packaging efficiency, and enhanced system performance. However, since the light source is located near the system chip, the system architecture design requires optical fibers to reliably transmit optical signals to an input/output (Input/Output, I/O) panel. During this process, the issue of efficiently assembling and managing optical fibers needs to be addressed.

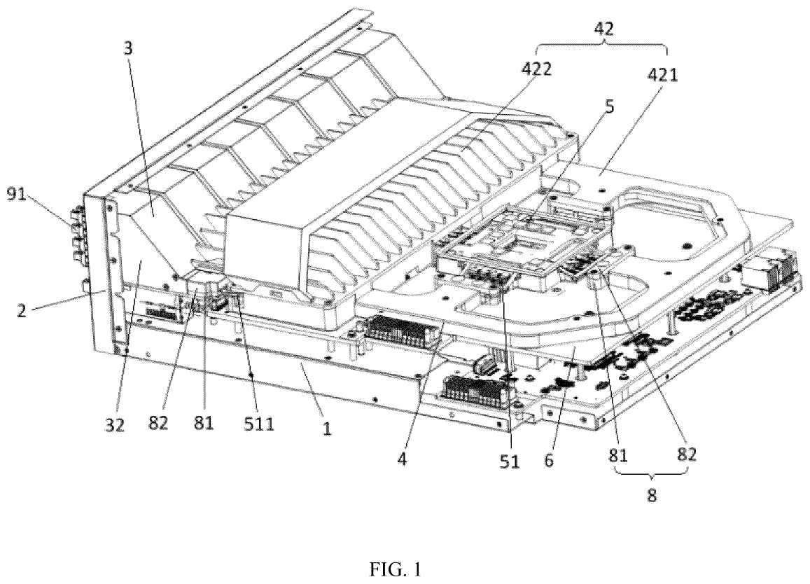

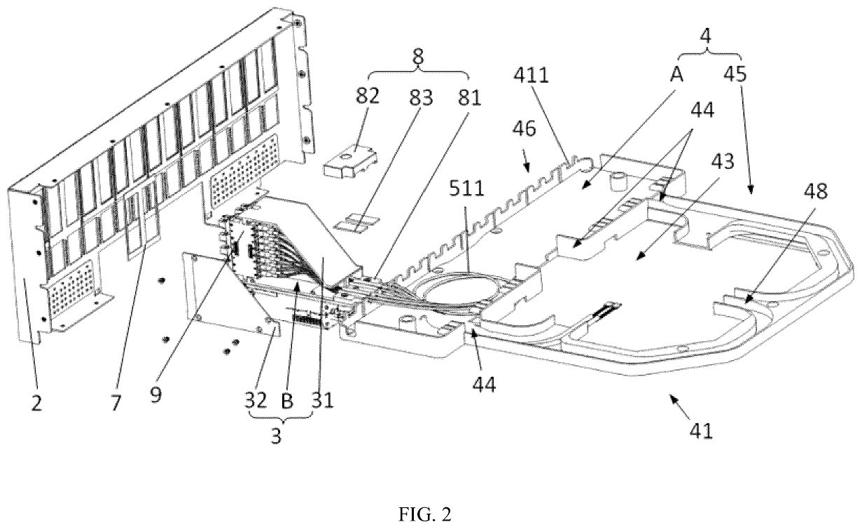

As shown in FIG. 1 and FIG. 2, an embodiment of this application provides an optical fiber management apparatus for co-packaged optics switch chip, including: a support substrate 1 including a first surface; an optical fiber storage box 3 disposed on the first surface of the support substrate 1; and a cable management structure 4 disposed on the first surface of the support substrate 1 and including: a cable management portion 45 having a first optical fiber outlet 44; and a first optical fiber storage space A having a second optical fiber outlet 46, where the first optical fiber outlet 44 is configured to allow an optical fiber in the cable management portion 45 to extend into the first optical fiber storage space A, the second optical fiber outlet 46 is configured to allow the optical fiber in the first optical fiber storage space A to extend into the optical fiber storage box 3, and the first optical fiber storage space A is configured to accommodate a first redundant portion of the optical fiber. The first optical fiber storage space A is located between the cable management portion 45 and the optical fiber storage box 3.

Optionally, the optical fiber storage box 3 includes a second optical fiber storage space B, and the second optical fiber storage space B is configured to accommodate a second redundant portion of the optical fiber.

In one implementation, the optical fiber management apparatus for co-packaged optics switch chip may include: a support substrate 1, a panel 2, an optical fiber storage box 3, and a cable management structure 4; the panel 2 is mounted at an end portion of the support substrate 1; the support substrate 1 may include a first surface, and both the optical fiber storage box 3 and the cable management structure 4 are fixedly disposed on the first surface. The cable management structure 4 may include a cable management portion 45 and a first optical fiber storage space A. The cable management structure 4 may further include a hollowed-out region 43 configured to expose a chip assembly 5 fixedly disposed on the support substrate 1; along a routing direction of an optical fiber 511, an optical fiber inlet of the cable management structure 4 faces the hollowed-out region 43, an optical fiber inlet of the optical fiber storage box 3 is opposite an optical fiber outlet of the cable management structure 4, and an optical fiber outlet of the optical fiber storage box 3 is opposite an optical fiber interface on the panel 2; and the optical fiber storage box 3 and/or the cable management structure 4 has an optical fiber storage space.

The above optical fiber management apparatus is configured to manage optical fibers 511 of a co-packaged optics switch chip, where a chip assembly 5 including the co-packaged optics switch chip is mounted on the first surface of the support substrate 1 and located within the hollowed-out region 43 of the cable management structure 4. Both the cable management structure 4 and the optical fiber storage box 3 are fixed on the first surface of the support substrate 1, and the panel 2 is fixed at the end portion of the support substrate 1; and optical fibers 511 connected to the chip assembly 5 pass through the cable management structure 4 and the optical fiber storage box 3 to reach the panel 2, thereby transmitting optical signals to the panel 2. The cable management structure 4 surrounds the chip assembly 5 via the hollowed-out region 43, facilitating entry of optical fibers 511 into the cable management structure 4. In addition, optical devices 51 at different positions around the chip in the chip assembly 5 require optical fibers 511 of varying lengths for signal connection to the panel 2, and the cable management structure 4 and/or the optical fiber storage box 3 can provide additional optical fiber storage space. For example, an interior of the cable management structure 4 may have an optical fiber storage space A, and an interior of the optical fiber storage box 3 may also have an optical fiber storage space B, facilitating the consistency of the lengths of optical fibers 511.

It should be noted that the chip assembly 5 is mounted on the support substrate 1 via a mainboard 6. The chip assembly 5 includes a co-packaged optics chip and one or more optical devices 51. A plurality of optical devices 51 may be provided, and the plurality of optical devices 51 are arranged around the co-packaged optics chip. The chip assembly 5 is located within the hollowed-out region 43 of the cable management structure 4. To be specific, a non-hollowed-out region of the cable management portion 45 of the cable management structure 4 surrounds the optical devices 51 and the co-packaged optics chip, facilitating entry of optical fibers 511 connected to optical devices 51 at different positions into the non-hollowed-out region of the cable management portion 45. As shown in FIG. 1, optical devices 51 are disposed around all sides of the co-packaged optics chip, and the cable management structure 4 is provided with an optical fiber inlet 48 at a position corresponding to each optical device 51, facilitating entry of optical fibers 511 connected to each optical device 51 into the non-hollowed-out region of the cable management portion 45.

As shown in FIG. 2, the cable management portion 45 is provided with an optical fiber storage space A (first optical fiber storage space) on a side near the optical fiber storage box 3; and redundant portions (first redundant portion) of optical fibers 511 of varying lengths can be stored in the optical fiber storage space A, facilitating the consistency of the lengths of portions of the optical fibers 511 outside the cable management structure 4. It can be understood that the first redundant portion may be all or part of a redundant portion of the optical fibers beyond a length required for routing.

In one embodiment, a top-view cross-section of the optical fiber storage space A may be rectangular.

Additionally or alternatively, an optical fiber storage space B (second optical fiber storage space) may be provided on a side of the optical fiber storage box 3 near the cable management structure 4. If the lengths of optical fibers 511 stored in the optical fiber storage box 3 differ, a redundant portion (second redundant portion) of the optical fibers 511 in the optical fiber storage box 3 can be accommodated in the optical fiber storage space B; that is, the optical fiber storage space B can absorb excess optical fiber length, ensuring the consistency of the lengths of optical fibers outside the optical fiber storage space B in the optical fiber storage box 3. It can be understood that the second redundant portion may be all or part of a redundant portion of the optical fibers beyond a length required for routing.

In some embodiments, a height of the optical fiber storage space in a direction of optical fiber extension within the accommodation space gradually increases.

In some embodiments, an elastic shielding member (for example, conductive cotton 7) is disposed between the optical fiber storage box 3 and the panel 2.

In one possible implementation, as shown in FIG. 1 and FIG. 2, an optical fiber outlet of the optical fiber storage box 3 may be a connection point between the optical fiber storage box 3 and the panel 2. The panel 2 is provided with a connector 9, and optical fibers 511 entering the optical fiber storage box 3 can be connected to the connector 9. A portion of the connector 9 is located within the optical fiber storage box 3, and another portion extends through the panel 2 and protrudes from an outer surface of the panel 2, with the protruding end of the connector 9 sealed with a dust cap 91 for dust protection. The connector 9 may be a single-optical fiber bidirectional Lucent connector (Lucent Connector, LC). The outer surface of the panel 2 may be a surface of the panel 2 facing away from the optical fiber storage box 3. To ensure electromagnetic compatibility (Electromagnetic Compatibility, EMC) shielding of the connector 9 in the system, the optical fiber storage box 3 overlaps the panel 2 via an elastic shielding member to prevent EMC leakage. The elastic shielding member not only serves to shield against leakage but also adjusts installation precision between the optical fiber storage box 3 and the panel 2 through its elasticity.

In some embodiments, the elastic shielding member is conductive cotton 7. Conductive cotton 7 exhibits excellent conductivity and electromagnetic wave shielding performance. Conductive cotton 7 is also elastic. Adding conductive cotton 7 between the optical fiber storage box 3 and the panel 2 not only compensates for installation tolerances between the optical fiber storage box 3 and the panel 2 but also provides effective shielding to prevent EMC leakage.

In some embodiments, the hollowed-out region 43 is located at a central portion of the cable management portion 45 of the cable management structure 4. The cable management structure 4 is provided with a plurality of optical fiber inlets, and the plurality of optical fiber inlets are spaced apart around the hollowed-out region 43.

In one possible implementation, as shown in FIG. 2, the hollowed-out region 43 is located at a center position of the cable management portion 45 and has an approximately square structure. Corresponding to optical devices 51 on four sides of the chip assembly, the cable management structure 4 is provided with four optical fiber inlets 48; and the four optical fiber inlets 48 are spaced apart around the four sides of the square hollowed-out structure, facilitating entry of optical fibers 511 connected to optical devices 51 at different positions into the non-hollowed-out region of the cable management portion 45. Optical fibers 511 connected to an optical fiber inlet 48 on the cable management structure 4 relatively far from the optical fiber storage box 3 are routed around the hollowed-out region 43 before entering the optical fiber storage space A on the cable management structure 4, facilitating accommodation of a redundant portion of the optical fibers 511 in the optical fiber storage space A.

In some embodiments, an optical fiber fixing assembly 8 is disposed at the optical fiber inlet of the cable management structure 4 and/or at the optical fiber inlet of the optical fiber storage box 3. The optical fiber fixing assembly 8 includes an optical fiber fixing base 81 and an optical fiber fixing pressing block 82; the optical fiber fixing base 81 is provided with an optical fiber fixing groove extending through the optical fiber fixing base 81, and an opening is provided on a side of the optical fiber fixing groove facing away from the support substrate 1; and the optical fiber fixing pressing block 82 is fixedly disposed on the optical fiber fixing base 81 and covers the opening.

In one possible implementation, as shown in FIG. 1, an optical fiber fixing assembly 8 is disposed at the optical fiber inlet of the cable management structure 4 to fix optical fibers 511. The optical fiber inlet of the cable management structure 4 is near an optical device 51, and an optical fiber 511 is connected to the optical device 51. Since the optical fiber 511 needs to travel a long path to connect to the connector 9, to prevent connection failure due to movement of the optical fiber 511 relative to the optical device 51, an optical fiber fixing assembly 8 is disposed between the optical device 51 and the cable management structure 4, and the optical fiber 511 is placed in an optical fiber fixing groove of the optical fiber fixing base 81. The optical fiber fixing pressing block 82 is placed above the optical fiber 511 and fixed to the optical fiber fixing base 81 via connectors such as screws to press and secure the optical fiber 511. To protect the optical fiber 511, a portion of the optical fiber 511 within the optical fiber fixing groove is sleeved with a protective sleeve.

In one possible implementation, as shown in FIG. 2, an optical fiber fixing assembly 8 is disposed at the optical fiber inlet of the optical fiber storage box 3 to fix optical fibers 511. The optical fiber inlet of the optical fiber storage box 3 is near the optical fiber storage space A (first optical fiber storage space) of the cable management structure 4, and the optical fiber storage space A can accommodate a certain length of optical fibers 511. A volume of the optical fiber storage box 3 may be smaller than a volume of the cable management structure 4, and optical fibers 511 within the optical fiber storage box 3 are connected to the connector 9. An optical fiber fixing assembly 8 may be disposed between the optical fiber storage box 3 and the cable management structure 4, ensuring that even with vibration or movement, the optical fibers 511 are not easily displaced relative to the connector 9, thus preventing connection failure. The optical fiber 511 is placed in an optical fiber fixing groove of the optical fiber fixing base 81, and the optical fiber fixing pressing block 82 is placed above the optical fiber 511 and fixed to the optical fiber fixing base 81 via connectors such as screws to press and secure the optical fiber 511. To protect the optical fiber 511, a portion of the optical fiber 511 within the optical fiber fixing groove is sleeved with a protective sleeve.

It is worth noting that, in addition to securing and fixing the optical fiber inlet, the optical fiber fixing assembly 8 can also prevent EMC leakage.

In some embodiments, an elastic member is provided between the optical fiber fixing base 81 and the optical fiber fixing pressing block 82.

In one possible implementation, an elastic member, such as foam 83, is provided between the optical fiber fixing base 81 and the optical fiber fixing pressing block 82 to provide assembly tolerance space for the assembly of the optical fiber fixing base 81 and the optical fiber fixing pressing block 82 while protecting the optical fiber 511.

In some embodiments, the cable management structure 4 includes a main body 41 and a protective cover 42; and the protective cover 42 covers a side of the main body 41 facing away from the support substrate 1.

In one possible implementation, as shown in FIG. 1 and FIG. 2, the cable management structure 4 may have a substantially enclosed chamber structure, such that optical fibers 511 are not directly exposed to the environment, effectively protecting reliable connection of the optical fibers 511 within a system air duct and preventing movement of the optical fibers 511 under suction from a system fan, which could lead to poor optical signal transmission connection. The cable management structure 4 includes a main body 41 and a protective cover 42. The protective cover 42 may further include two parts: a first protective cover 421 and a second protective cover 422. The first protective cover 421 corresponds to the hollowed-out region 43 on the cable management structure 4, and the second protective cover 422 corresponds to the optical fiber storage space A on the cable management structure 4. The optical fiber storage space A can accommodate excess length of the optical fibers 511, achieving uniform routing of the optical fibers 511 for varying connection distances. In FIG. 1, the second protective cover 422 of the cable management structure 4 is further provided with a decorative cover, enhancing the aesthetic appearance of the cable management structure 4 and allowing for branding markings on the decorative cover.

It should be noted that the main body 41 and the protective cover 42 are arranged vertically, with an opening of the main body 41 facing directly upward to facilitate optical fiber management; and a large opening facilitates the placement of the optical fibers 511 in a coiled configuration into the optical fiber storage space A. The upward direction refers to the direction from the support substrate 1 to the cable management structure 4.

In some embodiments, the main body 41 is provided with a plurality of optical fiber-through grooves 411 at an optical fiber outlet of the cable management structure 4, such as at the second optical fiber outlet of the optical fiber storage space A (that is, first optical fiber storage space).

Since the optical fiber storage space A of the cable management structure 4 can store relatively long optical fibers 511, as shown in FIG. 2, excess lengths of the optical fibers 511 are coiled into a ring and stored in the optical fiber storage space A; due to the large number of optical fibers 511, to better secure and distinguish each optical fiber 511, the main body 41 is provided with a plurality of optical fiber-through grooves 411 at the optical fiber outlet of the cable management structure 4, where each optical fiber-through groove 411 may allow only one optical fiber 511 or a group of optical fibers 511 to pass through, facilitating optical fiber management and later maintenance.

In some embodiments, a volume of the accommodation space A is greater than a volume of the accommodation space B.

In some embodiments, the optical fiber storage box 3 includes a box body 31 and a lid 32; both the optical fiber inlet and the optical fiber outlet of the optical fiber storage box 3 are disposed on the box body 31; and the lid 32 covers the box body 31.

In one possible implementation, as shown in FIG. 2, the optical fiber storage box 3 has a substantially enclosed chamber structure, such that optical fibers 511 are not directly exposed to the environment, effectively protecting reliable connection of the optical fibers 511 within a system air duct and preventing movement of the optical fibers 511 under suction from a system fan, which could lead to poor optical signal transmission connection. The optical fiber storage box 3 includes a box body 31 and a lid 32; the lid 32 of the optical fiber storage box 3 is located on a side of the box body 31 and is also a side with the largest area among all sides of the optical fiber storage box 3, facilitating connection of the optical fibers 511 with the connector 9 and later maintenance.

In some embodiments, a plurality of optical fiber storage boxes 3 are provided, and the plurality of optical fiber storage boxes 3 are arranged along an extension direction of the panel 2.

In one possible implementation, as shown in FIG. 1 and in conjunction with FIG. 2, the optical fiber management apparatus provided in the embodiments is provided with a plurality of optical fiber storage boxes 3, and the plurality of optical fiber storage boxes 3 are arranged along a length direction of the panel 2; and the plurality of optical fiber storage boxes 3 all correspond to the same cable management structure 4. For example, a length direction of the optical fiber storage space A of the cable management structure 4 is the same as the length direction of the panel 2, and optical fiber inlets of the optical fiber storage boxes 3 all correspond to the optical fiber storage space A of the cable management structure 4 and are arranged along the length direction of the optical fiber storage space A.

The optical fiber management apparatus provided in the embodiments of this application features simplified production and assembly process, convenient adjustment and testing; and this apparatus can maintain consistent material lengths for varying optical fiber connection distances and effectively protect optical fiber cables.

Obviously, modifications and variations to the embodiments of this application can be made by those skilled in the art without departing from the spirit and scope of this application. As such, if these modifications and variations fall within the scope of the claims of this application or equivalent technologies thereof, this application is intended to encompass these modifications and variations.

1. An optical fiber management apparatus for a co-packaged optics switch chip comprising:
a support substrate comprising a first surface;
an optical fiber storage box disposed on the first surface of the support substrate; and
a cable management structure disposed on the first surface of the support substrate and comprising:
a cable management portion having a first optical fiber outlet; and
a first optical fiber storage space having a second optical fiber outlet, wherein the first optical fiber outlet is configured to allow an optical fiber in the cable management portion to extend into the first optical fiber storage space, the second optical fiber outlet is configured to allow the optical fiber in the first optical fiber storage space to extend into the optical fiber storage box, and the first optical fiber storage space is configured to accommodate a first redundant portion of the optical fiber.

2. The apparatus according to claim 1, wherein the optical fiber storage box comprises a second optical fiber storage space, and the second optical fiber storage space is configured to accommodate a second redundant portion of the optical fibers.

3. The apparatus according to claim 1, wherein the apparatus further comprises:
a panel mounted at an end portion of the support substrate; and
the cable management portion further comprises a hollowed-out region and a plurality of optical fiber inlets, wherein openings of the plurality of optical fiber inlets of the cable management portion face the hollowed-out region.

4. The apparatus according to claim 3, wherein an elastic shielding member is disposed between the optical fiber storage box and the panel.

5. The apparatus according to claim 4, wherein the elastic shielding member is conductive cotton.

6. The apparatus according to claim 3, wherein the hollowed-out region is located at a central portion of the cable management portion, and the plurality of optical fiber inlets are spaced apart around the hollowed-out region.

7. The apparatus according to claim 3, wherein the hollowed-out region has a square structure, the cable management portion is provided with four optical fiber inlets, and the four optical fiber inlets are respectively disposed corresponding to four sides of the hollowed-out region.

8. The apparatus according to claim 3, wherein an optical fiber fixing assembly is disposed at an optical fiber inlet of the cable management portion and/or at an optical fiber inlet of the optical fiber storage box; wherein
the optical fiber fixing assembly comprises an optical fiber fixing base and an optical fiber fixing pressing block; and
the optical fiber fixing base is provided with an optical fiber fixing groove extending through the optical fiber fixing base, wherein an opening is provided on a side of the optical fiber fixing groove facing away from the support substrate, and the optical fiber fixing pressing block is fixedly disposed on the optical fiber fixing base and covers the opening.

9. The apparatus according to claim 8, wherein an elastic member is provided between the optical fiber fixing base and the optical fiber fixing pressing block.

10. The apparatus according to claim 9, wherein the elastic member is foam.

11. The apparatus according to claim 3, wherein the cable management structure comprises a main body and a protective cover, and the protective cover covers a side of the main body facing away from the support substrate.

12. The apparatus according to claim 11, wherein the protective cover comprises a first protective cover and a second protective cover; the first protective cover corresponds to the hollowed-out region of the cable management portion; and the second protective cover corresponds to the first optical fiber storage space of the cable management structure.

13. The apparatus according to claim 11, wherein the first optical fiber storage space is provided with a plurality of optical fiber-through grooves at the second optical fiber outlet.

14. The apparatus according to claim 3, wherein the panel is provided with a connector; the connector comprises a first portion and a second portion, the first portion is located within the optical fiber storage box, and the second portion extends through the panel and extends beyond an outer surface of the panel.

15. The apparatus according to claim 14, wherein an end of the second portion extending beyond the outer surface of the panel is provided with a dust cap.

16. The apparatus according to claim 3, wherein the apparatus comprises another optical fiber storage box, and the optical fiber storage box and the other optical fiber storage box are arranged along an extension direction of the panel.

17. The apparatus according to claim 1, wherein the optical fiber storage box comprises a box body and a lid; and the lid of the optical fiber storage box is located on a side surface of the box body.

18. The apparatus according to claim 17, wherein the lid of the optical fiber storage box is a side having the largest area among a plurality of sides of the optical fiber storage box.

19. The apparatus according to claim 1, wherein the optical fiber storage box comprises a box body and a lid, both an optical fiber inlet and an optical fiber outlet of the optical fiber storage box are disposed on the box body, and the lid covers the box body.

20. The apparatus according to claim 1, wherein a volume of the optical fiber storage box is smaller than a volume of the cable management structure.
